(19) United States
(12) Patent Application Publication
(10) Pub. No.: US 2010/0114616 A1
(43) Pub. Date: May 6, 2010

(54) SYSTEM FOR MANAGING A FLEET OF MOTOR VEHICLES ACCESSIBLE VIA A STORAGE KEY AND METHOD FOR MANAGING THE CORRESPONDING FLEET

(75) Inventor: Monique Touati, Boulogne-Billancourt (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S, Boulogne-Billancourt (FR)

(21) Appl. No.: 12/532,636

(22) PCT Filed: Mar. 21, 2008
(86) PCT No.: PCT/FR08/50502

§ 371 Date: Dec. 31, 2009

(30) Foreign Application Priority Data
Mar. 23, 2007 (FR) 0754000

(51) Int. Cl. G06Q 10/00; G06F 19/00; G06Q 30/00; G06F 17/30

(52) U.S. Cl. 705/5; 701/2; 705/1.1; 707/783; 707/E17.005

(57) ABSTRACT

A system for managing a fleet of motor vehicles, including a central platform that can store data for the management of the fleet and an interface located remotely from the vehicle, enabling communication between a driver and the central platform. Each vehicle of the fleet can be accessed via a storage key that can store data relating to the identification and operation of the vehicle, as well as data relating to the fleet management contract, and which can be used to manage engine start-up/engine immobilization and locking/unlocking functions of the vehicle. Each key can be activated and released by the central platform at the user's request via the remote interface that can communicate with the central platform.

The present invention relates to the automated and shared management of vehicles belonging to a fleet, for example a fleet of vehicles of a company, or of a short- or long-term vehicle rental agency, or even a fleet of vehicles for shared use or carshare use.

Conventionally, vehicles that belong to this type of fleet of vehicles require, if they are to be managed automatically, dedicated on-board equipment in the vehicle called “telematics equipment”. Such equipment fulfills functions of communication with a central fleet management platform.

The telematics equipment can also be used, while the vehicle is in use, to collect certain control parameters (for example, fuel consumption or the degree of wear of certain parts) and relevant data (mileage, etc.) for billing for a service, for example a rental service.

However, such telematics equipment does have drawbacks, which become particularly problematic when it has to be reproduced in a large number of vehicles to fulfill these communication functions that are necessary for the service.

These drawbacks include cost, whether this be the cost of purchasing or installing the telematics equipment, servicing costs, or the cost of communications with the central platform.

Moreover, such equipment makes fuel management very complicated. In practice, said equipment is often restrictive for the user and for the manager of the fleet in terms of monitoring consumption and billing. For example, the equipment is often incompatible with the oil company cards that facilitate the taking of fuel by the holder of the vehicle originating from the fleet.

Another problem is management of the keys of the vehicles, which is often inefficient since:
either it requires the use of a staffed office,
or it raises problems of security, forgetfulness or loss, if the keys are kept by the user.

The document FR 2 792 754 proposes a system for controlling a fleet of motor vehicles. Each motor vehicle can be activated using a key associated with a badge. This badge can store vehicle identification information.

However, the quantity of information that can be stored on this badge is fairly limited, so it is not possible to carry out all the fleet, fuel and vehicle information management operations that a fleet manager has to carry out.

Furthermore, this document does not settle the problem of managing the keys of the vehicle. On the contrary, it complicates it by multiplying the number of objects needed to activate the vehicle.

The object of the invention is to improve the management of a fleet of motor vehicles, whether for the manager of the fleet in terms of quality and ease of management and cost, or for the user of the vehicle in terms of simplicity of use and security.

The invention sets out to define a system for managing a fleet of motor vehicles that can operate at limited cost, and that makes it possible to take into account a maximum of parameters concerning the management of the fleet proper, and the operation of the vehicle (mileage, fuel) while remaining easy to use.

To this end, according to a first aspect, there is proposed a system for managing a fleet of motor vehicles comprising a central platform which can store data for the management of the fleet and an interface located remotely from the vehicle, enabling communication between a driver and the central platform.

According to a general feature of this first aspect, each vehicle of the fleet can be accessed via a storage key which can store data relating to the identification and operation of the vehicle, as well as data relating to the fleet management contract, and which can be used to manage the start-up/immobilization and locking/unlocking functions of the vehicle, each key being able to be activated and released by the central platform (1) at the request of the user via said remote interface of the vehicle that can communicate with the central platform.

In other words, the communication between the interface located remotely from the vehicle and the driver and his vehicle is conducted via a storage key.

The benefit of this first aspect is that it allows all the information necessary for the management of the fleet (vehicle rental, for example), and for the vehicle itself (fuel, mileage, identification number, etc.) can be stored on a single medium.

Furthermore, the communication between the various elements of the system enables dynamic and fully automated fleet management.

Preferably, said storage key comprises a communication module which can communicate with the interface and/or the vehicle.

The use of a communicating storage key obviates the need to use a reading system integrated in any interface.

For example, the communication module can use a wired and/or wireless communication technology.

For example, said interface can be a logic controller comprising media for storing the storage keys of the vehicles of the fleet and a data medium. The logic controller can read and directly transfer the data from the keys to the platform.

Alternatively, said interface can be a computer.

This computer may be capable of communicating with the central platform via a computer network, for example an Internet network or an Intranet or Extranet network.

Moreover, said central platform may comprise an interactive application, a fleet management system and an information system.

Moreover, the information system may comprise billing means and booking means which can set up the communication between the user and the central platform, so that the user can book a vehicle of the fleet.

According to another aspect, there is proposed a method of managing a fleet of motor vehicles comprising a phase for storing data for the management of the fleet by a central platform and a communication phase between a user and the central platform via an interface located remotely from the vehicle.

According to a general characteristic of this other aspect of the invention,
each vehicle of the fleet is accessed using a corresponding storage key in which the data relating to the identification and operation of a vehicle is stored, together with data relating to the fleet management contract, and to the booking of said vehicle,
said central platform activates said storage key at the request of the user via said interface during the communication phase, so as to authorize any action of the user with respect to the vehicle.

Said storage key communicates directly with said interface and/or the vehicle. It is of communicating type.

The method includes a step for remotely making a vehicle of the fleet available to a user via a logic controller forming said interface. Said rental step comprises:
an identification of the user proving his membership of the service which gives him access to the fleet of vehicles by reading the data associated with the user,
an authentication of the membership rights of the user,
an assignment of a vehicle of the fleet to the user if the user is authenticated,
an identification of the storage key associated with the vehicle assigned to the user,
a reading and a transfer of the data necessary for the journey of the user, from the central platform to the identified storage key,
a releasing, by the logic controller, of the key assigned to the user.

Moreover, the method can include a step for the return of a vehicle of the fleet by a user via a logic controller forming said interface. Said return step may comprise:
an identification of said storage key associated with the returned vehicle, and the corresponding rental,
an authentication of the user and of his rights,
confirmation of the return of the vehicle,
a reading and a transfer of the data concerning the journey of the user, the condition of the vehicle from the storage key to the central platform,
closure of the rental of the vehicle, and, advantageously
a billing, either immediate or delayed, for the rental of the vehicle to the user.

Moreover, the method can include, prior to the vehicle rental step, a vehicle booking step.

The invention also relates to a logic controller for a system for managing a fleet of motor vehicles comprising a data medium which can manage information transferred by a central platform of the management system storing data for the management of the fleet, media for storing the keys of the motor vehicles, and a means for displaying useful information for a user of one of the motor vehicles.

The present invention will be better understood from reading the detailed description of an embodiment and a mode of implementation taken as a nonlimiting example and illustrated by the appended drawings in which:

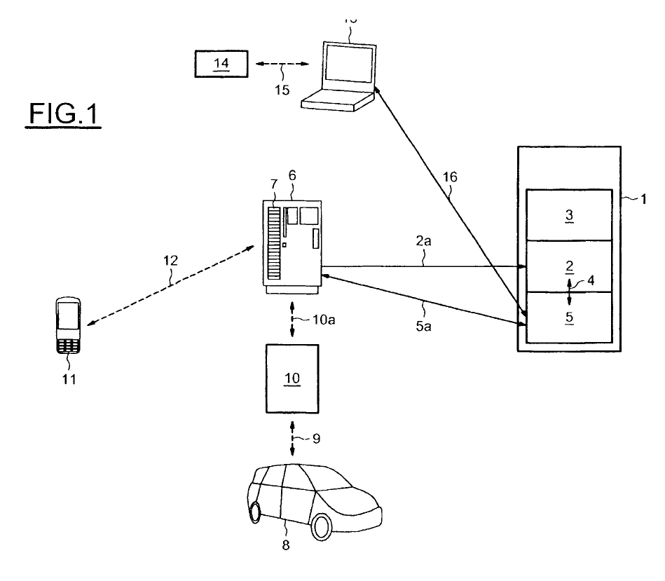

FIG. 1 diagrammatically represents a system for managing a fleet of motor vehicles according to the invention,

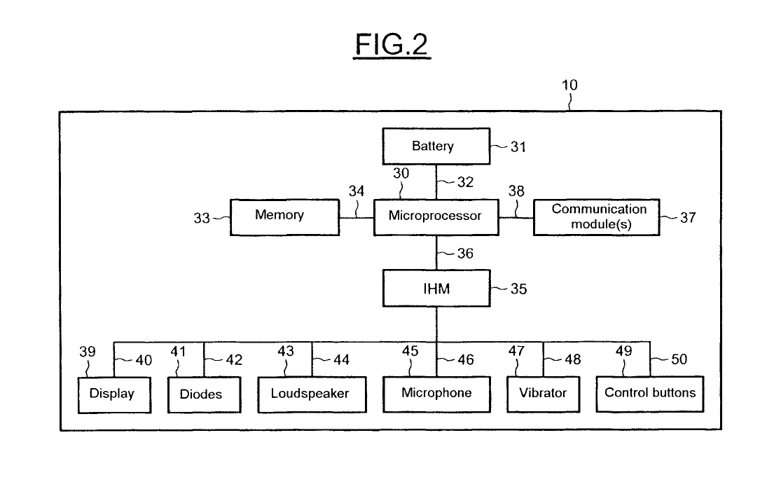

FIG. 2 illustrates an embodiment of a communicating key,

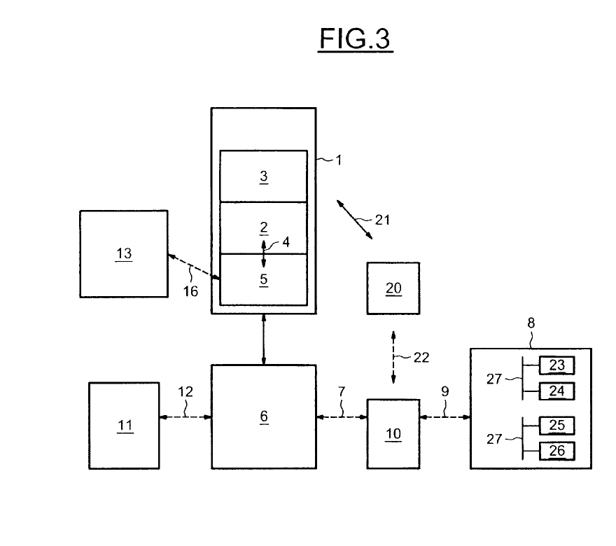

FIG. 3 more specifically illustrates the types of communication that can exist between the various modules implemented in the system for managing the fleet of motor vehicles,

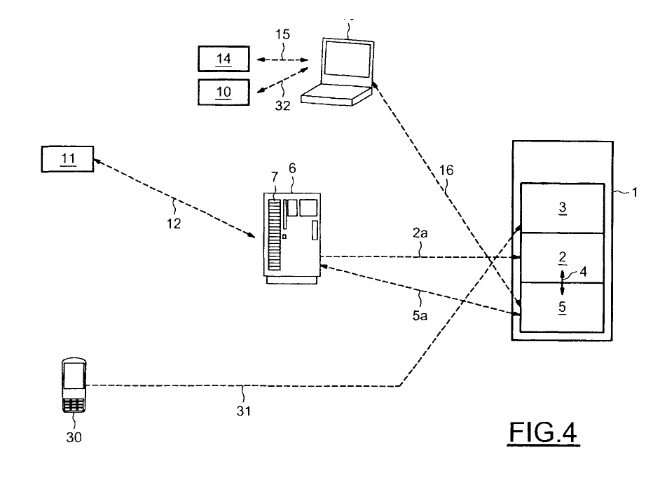

FIG. 4 illustrates the different booking means that can be used to book a vehicle of the motor vehicle fleet according to the invention,

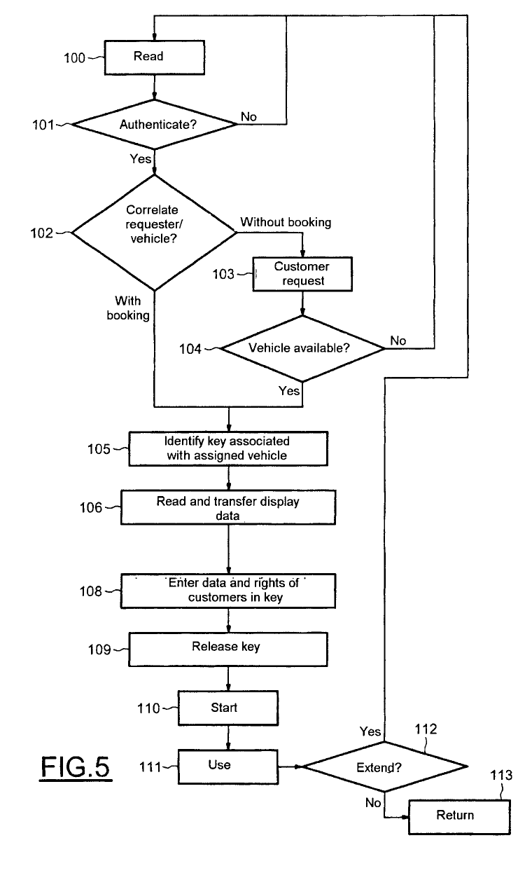

FIG. 5 illustrates the different steps in making a motor vehicle of a fleet available using a logic controller,

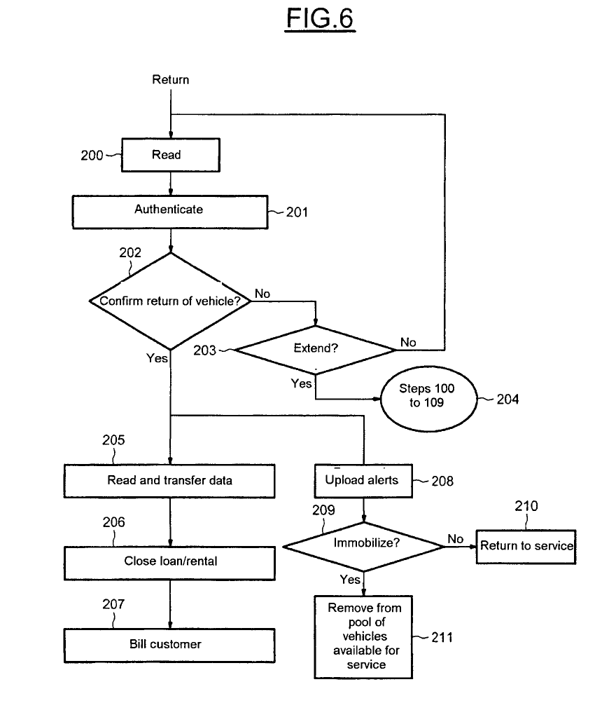

FIG. 6 illustrates the different steps in returning a vehicle of a fleet of motor vehicles, using a logic controller.

FIG. 1 shows one embodiment of a system for managing a fleet of motor vehicles.

The management system comprises a central platform 1 which can manage all the information regarding the fleet of motor vehicles such as their use and their billing. To do this, the central platform includes a fleet management system 2.

For example, the fleet management system 2 can manage the assignment of the vehicles, the number of incoming vehicles, the number of outgoing vehicles, the number of vehicles available, their rental, their maintenance, and so on.

The central platform 1 also includes an interactive application 3 which can inform the user as to his rights and the operation of the fleet of motor vehicles. The central platform (1) also includes an information system 5 which includes means of preparing the user's bill for the use of a motor vehicle (time, kilometers traveled, fuel, service, etc.).

The information system 5 also includes booking means for recording the booking of a vehicle made in advance or at the last minute by a user. The communication between the driver and the interactive application 3 is conducted via an interface, which will be described in more detail below.

The information system 5 and the fleet management system 2 can exchange data via a connection 4.

The interface between the central platform and the user/driver can be a key-based logic controller 6.

This logic controller 6 communicates with the information system 5. It receives information specific to the booking such as the identity of the booked vehicle, information associated with the customer or user of the booked vehicle, the booking time, and so on.

More specifically, the logic controller 6 comprises a number of media 7a containing the keys of the vehicle belonging to the motor vehicle fleet.

The logic controller 6 also includes a data medium, for example a memory (not shown in the interests of simplicity). This memory can be used to manage the information transferred by the central platform 1, and more specifically by the fleet management system 2 via a connection 2a and by the information system 5 via a connection 5a.

The logic controller 6 may comprise a display screen 7b so as to display information that is useful to the user. For example, the display screen 7b can be used to display safety information such as tire pressure and various fluid levels, and information associated with the rental of the vehicle.

The logic controller 6 identifies the user and communicates with him. This identification can be made via an interface (touch screen or keyboard for example) by reading a subscriber card, for example a chip card, or a company badge or any other medium including means of interaction with the logic controller and means for reading the identifier.

For example, a cell phone 11 illustrated in FIG. 1 may be used as a medium to transmit the identifier to the logic controller 6 via a wireless communication. As soon as the user's identifier is transmitted from any one of the media to the logic controller 6, and then by the latter to the interactive application 3 of the platform 1, this system returns to the logic controller 6 the authorization to make the vehicle available which results in the release of the corresponding vehicle key 10 in the key medium 7.

The logic controller 6 communicates with each storage key 10 via a connection 10a. This communication is conducted either via an integrated reader of RFID or USB type which can be used to read and write data from and to the storage keys, or remotely using a communication module incorporated in the storage key if said key is of communicating type. The communicating storage key will be described in more detail below.

The interface between the user and the central platform 1 can also be a computer 13, for example the user's personal computer. This interface is particularly suitable when the user has his own storage key 14.

The computer 13 communicates with the user's interactive application 3 and at the same time with the information system 5 via a network of Internet, Intranet or Extranet type. More specifically, it communicates with the booking system 5 via a connection 16 and which communicates in turn with the interactive application 3.

The personal storage key 14 of the vehicle and the computer 13 communicate with each other via a connection 15. This connection 15 can be provided either by a specific built-in reader, or by the communication module of the key if the key is of communicating type.

The storage keys are described, for example, in the document EP1138563.

A storage key offers the conventional functions of a vehicle key such as management of the immobilization, the starting-up and the locking/unlocking of the vehicle.

One type of storage key that is particularly suitable for use in a fleet management system via the logic controller for example can be used to store a vehicle identification number (or VIN number) for example. This number is assigned to the vehicle when it is manufactured: it is permanently inscribed in the memory of its key. Moreover, the memory can store data which is more particularly associated with management of the fleet. Such data is regularly updated.

More specifically, such rewritable data may include:
information associated with the vehicle (mileage, fluid levels, faults); such information is automatically transmitted from the vehicle 8 to its key 10, each time the vehicle's engine is switched on or off, or even while running; more generally, the vehicle transmits information that can be used by the after-sales service or by the various vehicle rental fleet technical repair or management maintenance services;
information relating both to the fleet management contract and the vehicle (details of the user, personal settings, contracts, servicing and repair history, emergency information, etc.);
multimedia information (audio, video, image, etc.).

Moreover, the integrity of the data stored in the key is ensured by the prevention of access to its memory. In practice, the user cannot access it directly, but must use the interactive application 3 via an interface (for example the logic controller 6) to load or unload data onto or from his key to make use of the services of the platform.

In the case where a communicating storage key is used with a personal computer, the direct and automatic connection of the key 14 to the computer 13 makes it possible to control access to the data.

The connection automatically triggers, via an automatic launching application, the opening of a browser window for the computer' s Internet application.

The identifier that corresponds to the vehicle identification number is automatically documented. The user then only has to enter his password.

This characteristic represents a huge benefit in terms of convenience, reliability and ease of use.

Reference is now made to FIG. 2 which illustrates a communicating storage key.

The communicating storage key preferably comprises a microprocessor 30, a battery 31 linked to the microprocessor via a connection 32, a memory 33 linked to the microprocessor via a connection 34 and a human/machine interface HMI 35 linked to the microprocessor by a connection 36.

The battery 31 can be recharged via a wired connection (such as a computer bus used to connect IT devices to a computer to communicate serially, otherwise called “USB”) to the user interface (laptop for example) or to the vehicle.

The memory 33 is intended to store all the data received either from the motor vehicle via a particular unit or from the user interface such as the user's laptop, or from the user himself directly via the human/machine interface 35.

The capacity of the memory 33 can extend to several hundreds of megabytes.

Moreover, the communicating storage key comprises one (or more) communication module(s) 37 linked to the microprocessor 30 by a connection 38.

The communication module 37 can communicate with surrounding elements using a wired or wireless network.

More specifically, the communication module is capable of setting up a communication:
between the vehicle and the user interface such as a personal computer or a telephone or a personal digital assistant linked to the Internet, so as to transmit information from the vehicle to the interface or vice versa,
with any communicating element of the management system such as a WiFi terminal.

The communication module 37 can enter into communication with the vehicle with which the key is associated via an on-board communication unit (not shown in the interests of simplicity).

Moreover, the microprocessor 30 is connected via the human/machine interface 35 to various auxiliary modules such as: a display 39 by a connection 40, one or more light-emitting diodes 41 by a connection 42, a loudspeaker 43 by a connection 44, a microphone 45 by a connection 46, a vibrator 47 by a connection 48, control buttons 49 by a connection 50.

Thus, the human/machine interface 35, coupled to these various auxiliary modules, makes it possible to provide the user with:
information on the status of the vehicle (locked or unlocked), information regarding the location of the vehicle, practical emergency information, configured via the service portal, all of this information being transmitted to the user via the display 39,
alerts, (service required, fuel level, expiry of rental agreement, etc.) by virtue of the display 39 and/or the diodes 41 and/or the vibrator 47,
voice memos (parking location, etc.) recorded by the microphone 45, or even music broadcast by the loudspeaker 45.

Alternatively, a software application fulfilling the functions described above (as well as vehicle access control and immobilization) and embedded in a communicating personal object (cell phone or PND or MP3 player or smart phone), can serve as the communicating storage key.

The communicating personal object can communicate with wireless technologies.

Reference is now made to FIG. 3 which illustrates the various possible modes of communication between the different elements that make up the motor vehicle fleet management system.

For example, the personal computer 13 used as user interface or booking means (as explained below) can communicate with the central platform 1 via an Internet/Intranet or Extranet type connection (connection 16).

The central platform 1 can communicate via a WiFi network 21 with a WiFi terminal 20 positioned, for example, in the place where the motor vehicles of the fleet are stored. This WiFi terminal 20 may, for example, be used to upload the data from the vehicles after they have been used, either because the vehicles communicate with this terminal, or the communicating storage key 10 which has stored said data communicates on a WiFi mode with this terminal, or a personal object communicates with the vehicle (on a wired or wireless mode).

The object used to identify the user (chip card, badge, cell phone) 11 can communicate with the key-based logic controller 6 via a “Bluetooth”, “RFId”, “USB” or “WiFi” type connection.

The key-based logic controller 6 can communicate with the communicating storage keys placed in its media 7a via a “Bluetooth”, “RFId”, “USB” or “WiFi” type connection 10a.

Finally, if the key is of communicating type, the connection 9 is of “Bluetooth”, “RFId” or “USB” type.

The vehicle 8 preferably comprises a serial system BUS (well known by the abbreviation CAN, standing for Controller Area Network), originating from computers 23, 24 or from sensors 25, 26.

Obviously, these modes of communication between the various elements of the management system are given by way of indication and are in no way limiting.

Reference is now made to FIG. 4 which illustrates the various means that can be used by the user to book a vehicle belonging to the fleet concerned.

The booking can be made via a service portal which is opened by the connection of the storage key 14, communicating or otherwise, specific to the user.

Furthermore, the interactive application 3 can offer additional services such as navigation assistance, customized settings or multimedia applications.

The booking can also be made using the user's cell phone 30 or any other communicating object.

The cell phone 30 can be used to directly access the booking system 3 via a connection 31. The user can then download his rights and the information associated with his booking to his cell phone 30.

The user can extend his booking or even book a vehicle at the last minute using his user card and/or subscriber card or any other interface (terminal) providing access to the booking application via the logic controller 6. The booking can also be extended using a communicating storage key. The connection of this key to the interactive application 3 associated with the central platform and accessible from a PC makes it possible to extend the booking. The user's new rights can be programmed directly into the key 10 of the vehicle and can be communicated to the appropriate interface.

Reference is now made to FIG. 5 which illustrates the various steps of a mode of implementation of the method according to the invention regarding the loan for hire of a motor vehicle using a logic controller.

Firstly, the logic controller reads the card, the badge, or any other user or subscriber element 100.

The rights of the subscriber are authenticated 101 by virtue of the user' s password. If the authentication fails, it is not given following the request from the user or from the subscribing user.

Otherwise, the authenticated user confirms his request via the interface. The information is transmitted by the logic controller 6 to the booking system via a communication. Direct local correlation via the platform between a booked vehicle of the fleet and the user is then made 102. If no booking has been made, the interactive application 3 studies the request from the user 103. If no vehicle is available 104, the request from the subscribing user is not followed up.

If a booking has been made or if a vehicle is available in the case of a request from a user without booking, the logic controller identifies the key associated with the vehicle which has been assigned in the correlation step 105.

The logic controller reads the data coming from the central platform and transfers it to the key 106 of the assigned vehicle. The transfer is carried out either using an appropriate reader (case of a non-communicating key) or by virtue of the communication module incorporated in the key (case of a communicating key).

Some of the information intended for the user is displayed, for example, on the screen of the logic controller or else on the screen of the storage key or even on a ticket printed by the logic controller for the user before the user leaves. This information informs the user as to the condition of the vehicle.

Data and rights associated with the rental of the vehicle are then inscribed in the key given to the user 108: rental of the vehicle, booking data, journey information (itinerary for example).

Then, the logic controller releases the key corresponding to the booked vehicle 109 for the departure of the vehicle 110.

At the end of the use 111 of the vehicle, the user can extend 112 his booking. In this case, the steps 100 to 111 are repeated.

Otherwise, the user returns the vehicle 113.

The return of the vehicle is described in more detail below.

FIG. 6 illustrates the various steps for returning the vehicle leased or borrowed by the user.

On return, the logic controller reads the data from the key of the vehicle used by the user 200. The key is identified and the customer authenticated 201. Then, a confirmation of the return of the vehicle 202 is requested. Otherwise, the logic controller asks if the user wants to extend the rental or the loan 203. If the user does not want to extend, the request is not followed up.

If the user confirms the extension request, the rental steps 100 to 109 described previously are repeated 204.

If the user confirms the return of the vehicle, the logic controller reads the data stored by the storage key during the use of the vehicle that has just been returned. This data is then transferred to the central platform 205, more specifically to the information system 5 and also to the interactive application 3 to progress the booking.

The loan or rental of the vehicle is then terminated 206.

A bill will be output subsequently to the user 207 by the billing means of the information system 5.

Moreover, at the same time as the operations performed for the user, the information regarding the condition of the vehicle and any alerts stored within the storage key are sent to the fleet management system 2 of the central platform 208.

The various alerts may lead to a possible immobilization of the vehicle triggered by the fleet management system 2, 209. If this is not necessary, the vehicle is then returned to service 210.

Otherwise, the vehicle is removed from the fleet of motor vehicles available for rental until it has been repaired.

The motor vehicle fleet management system is therefore very easy to use for the user, compared to a vehicle that has an on-board communication system (telematics).

However, the costs of the management system as described above are greatly reduced, since there is no longer a need to equip all the vehicles with an on-board communication system.

More particularly, this system is suitable for services that require management of a fleet of vehicles in car sharing use, automobile self service, pools of company vehicles not dedicated to specific people, automated short-term rental, more or less with no booking office.

In practice, provided that a certain number of vehicles remains grouped in one and the same area, while remaining easy to use, the system makes it possible to activate vehicle access, start-up and data management functions and the remote delivery of the corresponding keys, without it being necessary to equip these vehicles in a costly way, which is the case with the most automated car sharing systems.

For services that normally have a booking office (company pools, short-term rental for example), the benefit of the administrative simplification and the time saving for users and managers is significant. Also, the availability of the services is improved since such a system provides access thereto at all times.

1-14. (canceled)

15. A system for managing a fleet of motor vehicles, comprising:
a central platform that can store data for management of the fleet; and
a remote interface located remotely from the vehicle, enabling communication between a user and the central platform, wherein each vehicle of the fleet can be accessed via a storage key that can store data relating to identification and operation of the vehicle, and data relating to a fleet management contract, and which can be used to manage start-up/immobilization and locking/unlocking functions of the vehicle, each key to be activated and released by the central platform at a request of the user via the remote interface of the vehicle that can communicate with the central platform.

16. The system as claimed in claim 15, in which the storage key is of communicating type and comprises a communication module that can communicate with the central platform.

17. The system as claimed in claim 15, in which the interface can communicate with the central platform via a network using Internet technologies.

18. The system as claimed in claim 15, in which the interface is a logic controller that can store the storage keys of the vehicles of the fleet.

19. The system as claimed in claim 15, in which the interface is a computer.

20. The system as claimed in claim 15, in which the central platform comprises an interactive application, a fleet management system, and an information system.

21. The system as claimed in claim 20, in which the information system comprises billing means and booking means that can set up communication between a user and the central platform so that the user can book a vehicle of the fleet.

22. A method of managing a fleet of motor vehicles comprising:
storing data for management of the fleet by a central platform; and
a communication between a user and the central platform via an interface located remotely from the vehicle;
wherein each vehicle of the fleet is accessed using a corresponding storage key in which data relating to identification and operation of a vehicle is stored, together with data relating to a fleet management contract, and
the central platform activates the storage key at a request of the user via the interface during the communication, to authorize any action of the user with respect to the vehicle.

23. The method as claimed in claim 22, in which the storage key is of communicating type.

24. The method as claimed in claim 22, further comprising rental by a user of a vehicle of the fleet via a logic controller forming the interface, the rental comprising:
an identification of the user proving his/her membership of a service that gives him/her access to the fleet of vehicles by reading the data associated with the user;
an authentication of membership rights of the user;
an assignment of a vehicle of the fleet to the user if the user is authenticated;
an identification of the storage key associated with the vehicle assigned to the user;
a reading and a transfer of the data necessary for a journey of the user, from the central platform to the identified storage key; and
a releasing, by the logic controller, of the key assigned to the user.

25. The method as claimed in claim 24, further comprising returning a vehicle of the fleet by a user via a logic controller forming the interface, the returning comprising:
an identification of the storage key associated with the returned vehicle, and the corresponding rental;
an authentication of the user and of his/her rights;
confirmation of return of the vehicle;
reading and transfer of the data concerning the journey of the user, the condition of the vehicle from the storage key to the central platform; and
closure of the rental of the vehicle.

26. The method as claimed in claim 24, further comprising billing for rental of the vehicle.

27. The method as claimed in claim 26, further comprising, prior to the vehicle rental, a vehicle booking.

28. A logic controller for a system for managing a fleet of motor vehicles as claimed in claim 15, comprising a data medium that can manage information transferred by a central platform of the management system storing data for the management of the fleet, media for storing the keys of the motor vehicles, and means for displaying useful information for a user of one of the motor vehicles.
